(19) United States
(12) Patent Application Publication
(10) Pub. No.: US 2012/0187265 A1
(43) Pub. Date: Jul. 26, 2012

(54) Detachable umbrella, walking stick/cane, crutch holder for use on mobility vehicle such as but not limited to electric scooters, electric wheelchairs, wheelchairs and walkers

(76) Inventor: Martin Roy Bakerman, Hialeah, FL (US)

(21) Appl. No.: 12/931,188

(22) Filed: Jan. 26, 2011

(51) Int. Cl. F16M 13/02

(52) U.S. Cl. 248/220.22

(57) ABSTRACT

A device that easily attaches and detaches to brackets which have been attached to a tube be it round, square, or rectangle, found on a mobility unit such as but not limited to an electric scooter, electric wheelchair, manual wheelchair, walker, or other similar vehicle, to temporarily secure, attach, or hold any object that contains at least one or more legs, tips or ends, such as an umbrella, a walking stick, a walking cane, a crutch or other item. The tube to which the device is attached may be vertical or angled as much as halfway between vertical and horizontal. The device is easily removable from the mobility unit, with or without the object that it is being used to secure, attach, or hold, still attached, secured, or held, in order to facilitate folding, storing, or transporting the mobility unit.

### CROSS-REFERENCE TO RELATED APPLICATIONS

Title: Umbrella Holder

Inventor: Thomas B. Comins

U.S. Pat. No.: 494,123

Filing Date: Jul. 18, 1892

Issue Date: Mar. 18, 1893

Title: Walking Cane Holder Apparatus

Inventor: Jack M Hutchinson, et al

U.S. Pat. No.: 6,691,722

Filing Date: Jun. 19, 2002

Issue Date: Feb. 17, 2004

Title: Cane Holding Apparatus and Method

Inventor: Jackie B Crysor

U.S. Pat. No.: 6,000,414

Filing Date: Dec. 11, 1997

Issue Date: Dec. 14, 1999

Title: Multipurpose Carrying System

Inventor: Giancarlo Caputi

Application Ser. No.: 91,794,071

Filing Date: Feb. 28, 2001

Publication Number: US 2002/0008125A1

### BACKGROUND OF THE INVENTION

A. Field of the Invention

The present invention relates to a device that easily attaches and detaches to any vertical or nearly vertical upright tube to hold or secure for a temporary time an item such as, but not limited to an umbrella, a walking stick, a walking cane, a crutch or other items, that is wished to be carried or taken with the user but that is not wished to be carried by hand while user is on or utilizing a mobility unit such as but not limited to an electric scooter, electric wheelchair, manual wheelchair or walker, thus freeing the hands. The device, object of the present invention, is easily removable, with or without the item being held or secured still attached, from the mobility unit in order to facilitate folding, storing, or transporting the mobility unit.

B. Description of the Related Art

Many items are used and /or required by the users of mobility vehicle, these items include but are not limited to umbrellas or walking assistance devices such as walking sticks, canes and crutches. These items however are not normally used simultaneously with the mobility vehicles but rather at times when the mobility vehicle is not being used. It is difficult, clumsy, uncomfortable or dangerous to hold them by hand or between the user's legs or to balance them precariously on the floor of the mobility vehicle while operating the mobility vehicle. Most conventional methods of securing these items by means of tying them on to the vehicle or using bungee cords to secure them are clumsy and/or time consuming or ineffective. As a result it would be highly beneficial to have an improved simple method of attaching them securely and removing them quickly to and from the mobility vehicle.

Similar to the need to be able to carry an umbrella hands free, yet close at hand, it is important to maintain the item in a secure manner while operating a mobility vehicle. Accordingly, devices such as disclosed in the patent to Thomas B. Cumins, U.S. Pat. No. 494,123 are provided. The device of Cumins specifically provides a device which attaches to a garment, but could by its very design, attach to other objects such as a mobility device, to hold an item such as an umbrella or cane, or other article. While such a device does provide a method to carry an article such as an umbrella, it requires the item carried to have a handle or end that is substantially wider than the shaft in order to keep it from sliding through the device. Furthermore it requires the item being attached to be shorter than the device that it is being attached to, as the method of carrying the item is to hang it from the device or article of clothes. Still furthermore the item being carried or secured by Cumins, device will have a tendency to sway or rock from side to side as it is being held at only one point and that point being on one of the extreme ends of the item being carried.

In comparing some of the prior art devices one can consider Giancarlo Caputi, Patent Application Publication US 2002/0008125 A1, which uses a multitude of carrying straps in different configurations as required to fit the particular use with the particular article/s one wishes to secure or carry. It is important to be able to change from one item to another item that one wishes to attach or carry with the device without having to change the entire configuration of the device. While Caputi's carrying system could be used to carry items that are similar to those being attached or carried by the device, object of this present invention, It is important to be able to carry items such as, but not limited to, an umbrella, a walking stick, a walking cane or a crutch without extending the width of the mobility vehicle to which they are attached, this is accomplished by carrying or attaching them in a vertical or near vertical position.

Some of the prior art devices such as Crysor, U.S. Pat. No. 6,000,414 and/or Hutchinson, U.S. Pat. No. 6,691,722 require altering the item to be secured by attaching a piece of Velcro to the item being secured and another to the device which it is going to be secured to. These methods carry the full weight of the item at the point where the Velcro pieces meet. The device, object of the present invention, sustains the weight of the item being carried or secured at the base of the item and supports the weight much more securely.

Crysor and Hutchinson prior art devices are attached toward the top of the item being carried and therefore the item being carried will hang in a vertical manner and will not allow it to be carried in any near vertical but not vertical manner. Still furthermore the item being carried or secured by Crusor and/or Hutchinson device will have a tendency to sway or rock from side to side as it is being held at only one point and that point being on one of the extreme ends of the item being carried.

All prior art devices do not offset the item being carried which allows normal functions on the mobility devices to operate in a way that they were designed, in example, the arms would not be able to be raised. The device, object of the present invention, is designed with an offset from the object it is attached to accommodate this situation.

### BRIEF SUMMARY OF THE INVENTION

The present invention is directed toward a holder that easily attaches and detaches to an electric scooter, electric wheelchair, manual wheelchair, walker, or other similar device, to temporarily secure, attach, hold or carry any object that contains at least one or more legs, tips or ends, such as, but not limited to an umbrella, a walking stick, a walking cane, a crutch or other item. The device, object of the present invention, is easily attached or removed from the mobility unit by means of two hanger prongs which fit into or slide into two hanger brackets which are attached to the mobility device either in a permanent fashion by the use of glue or screws or any other way to permanently affix them or they may be attached in a way that facilitates their removal by the use of one of the countless clamps or connectors that are readily available in the market place.

It is the object of the present invention to provide a method to carry an umbrella, a walking stick, a walking cane, a crutch or other item hands free, while using or operating a scooter or other mobility device yet maintaining the object within reach and easily detachable in order to remove or use the object when it is required or needed.

Still another object of the present invention is to be able to be used for different items at different times according to the wants, needs or preferences of the user. In example, the same object of the present invention could be used at one time to carry a walking stick and at another time, an umbrella.

Still another object of the present invention is to provide a variety of methods to carry diverse items with different sizes, thickness, circumference or diameter using the same object of the present invention and attaching the item/s with the more appropriate or useful complimentary attachment devices such as Velcro strips, rings or short tubes, clips, and/or bungee ties.

Still another object of the present invention is to provide a method of attaching said object of the present invention to its host mobility vehicle facing any direction that is preferred in order to make use of the object of the present invention more effectively or comfortably. The object of the present invention may be attached on a square, round or rectangular tube that is angled anywhere from the midpoint between horizontal and vertical to completely vertical or upright and could be facing forward, backward, inward or outward in relation to the mobility vehicle, where the vehicle's design allows it to be placed so that it may be utilized in a workable manner.

Still another object of the present invention is to provide a method of carrying more than one object at the same time by the use of more than one unit, object of the present invention. This is accomplished by placing more than one unit on the same square, round, or rectangle tube, that is angled anywhere from the midpoint between horizontal and vertical to completely vertical or upright as an example on an arm rest support.

Still another object of the present invention is to provide a method of a simple way to remove both the object of the present invention and the item that is being held or carried by the present invention simultaneously while the item being held or carried is still attached to the present invention. While remaining so attached they may also be simultaneously simply and easily re-installed on the vehicle from which they were removed.

A further object of the present invention is the ability of easily removing and re-installing the object of the present invention in order to facilitate folding, storing, moving, or any other reason where the object of the present invention still attached is of an issue, such as the overall height of the vehicle.

Another object of the present invention is the ability of being used without disabling or making useless any of the design and function elements of the vehicle on which it is being used.

### BRIEF DESCRIPTION OF THE DRAWINGS

For a fuller understanding of the re of the present invention, reference should be had to the following detailed description taken in connection with the accompanying drawings in which:

FIG. 1 is a perspective view of the present invention.

FIG. 2 is a perspective view of a first embodiment of the present invention in its unattached form.

FIG. 3 is a perspective view of a first embodiment of the present invention in its attached form.

FIG. 4 is a profile view of a second embodiment of the present invention in its attached form.

FIG. 5 is a profile view of a third embodiment of the present invention in its attached form.

FIG. 6 is a profile view of a fourth embodiment of the present invention in its attached form.

FIG. 7 is a perspective view of some methods to secure or hold items to the present invention.

FIG. 8 is a perspective and a profile view of an optional insert to enhance the present invention to allow larger base or tip items to be secured or held.

FIG. 9 is a perspective view of a first embodiment of the present invention in its attached form being used on an electric scooter.

Like reference numerals refer to like parts throughout the several views of the drawings.

### DETAILED DESCRIPTION OF THE INVENTION

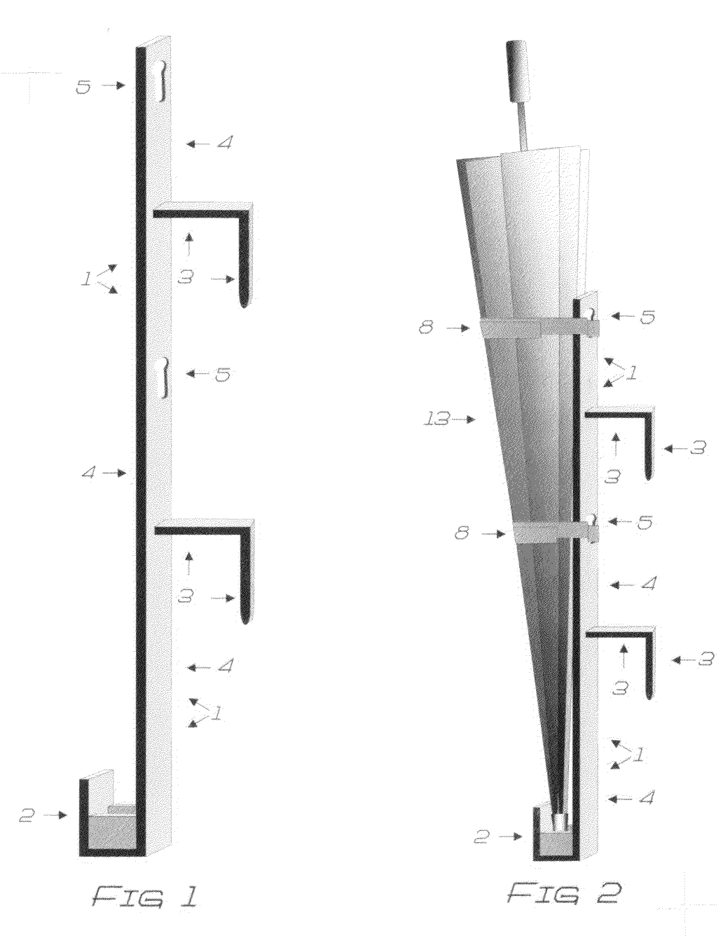

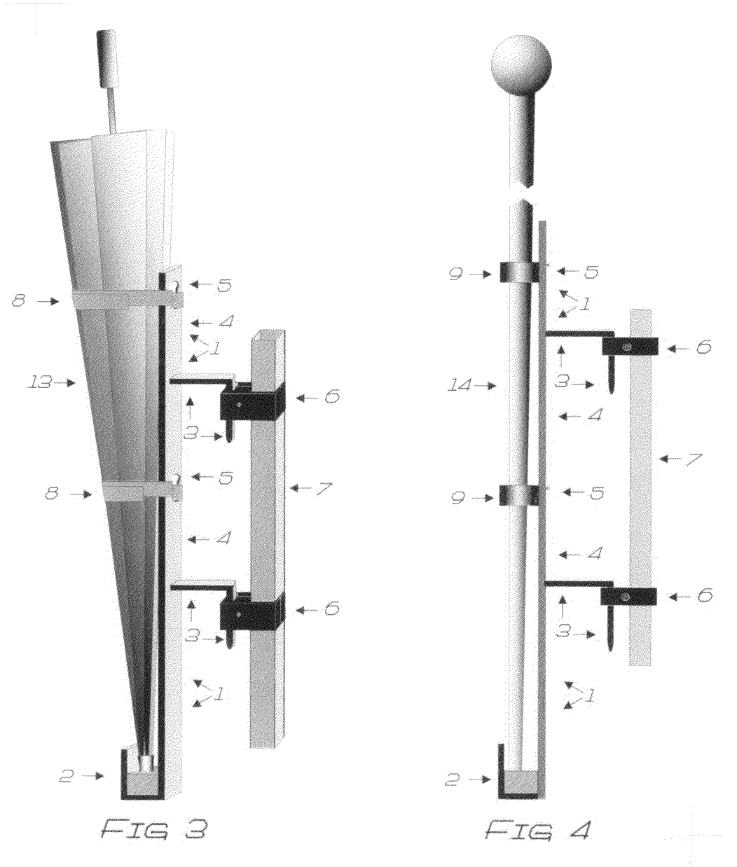

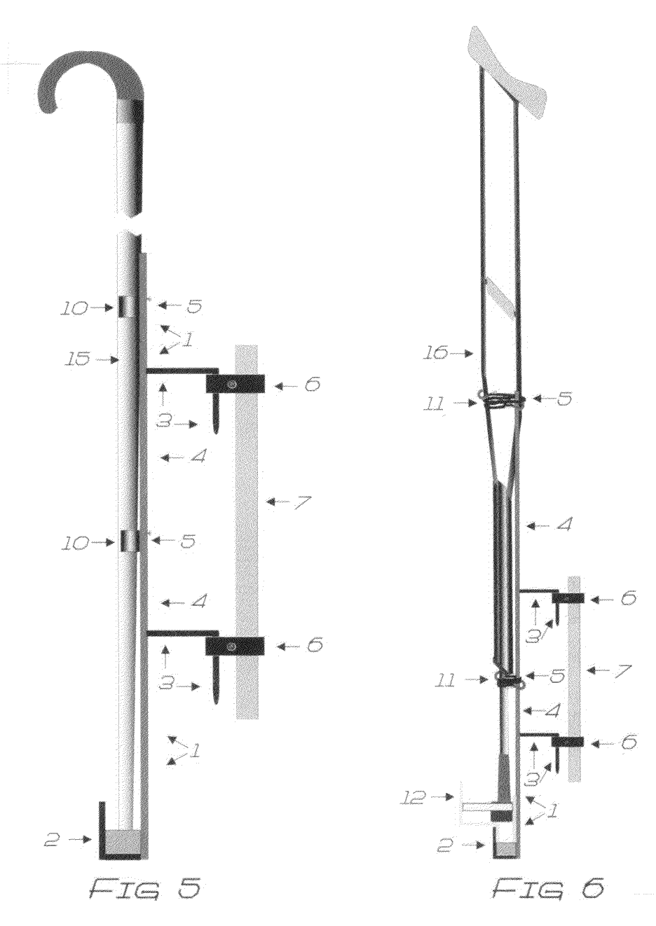

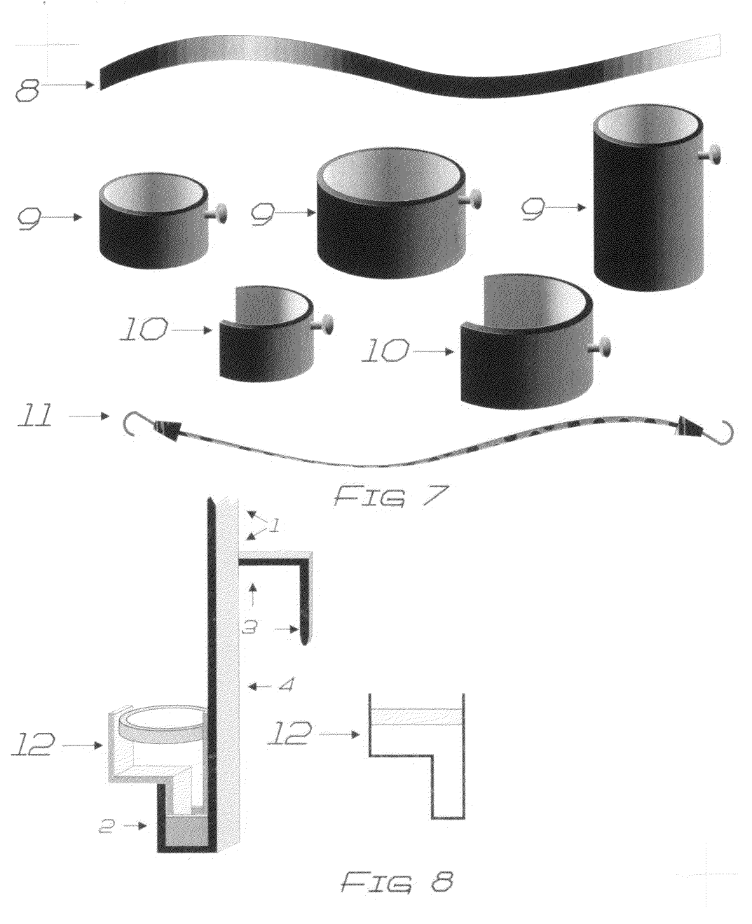

Shown throughout FIGS. 1-8, the present invention is directed toward an attachable/detachable device that is used to hold any object that contains at least one or more legs, tips or ends. Specifically, the detachable holder, object of the present invention 1 (see FIG. 1), is to be utilized on a mobility unit to temporarily hold or secure an item the user does not wish to carry or hold in their hands at that given moment. As shown in the figures, the item being held or secured can be an umbrella 13 (see FIG. 2 & FIG. 3), a walking stick 14 (see FIG. 4), a walking cane 15 (see FIG. 5), a crutch 16 (see FIG. 6), These embodiments, however are only illustrative of the numerous types of items for which this attachable/detachable holding devise, the object of the present invention could be effectively utilized. In fact any item which presently exists or is developed that has an edge, end or tip that fit into the support 2 or into the insert extender for larger bases or tips 12 (see FIG. 6 & FIG. 8), is within scope of the present invention. This present invention is attachable/detachable to any anchor tube 7 located on a mobility vehicle (as an example the tube/s that support the arm rests on an electric scooter), such as but not limited to electric scooters, electric or manual wheelchairs, walkers or any other type of mobility vehicle which presently exists or is developed on which the present invention can be placed used or connected to, is within the scope of the present invention.

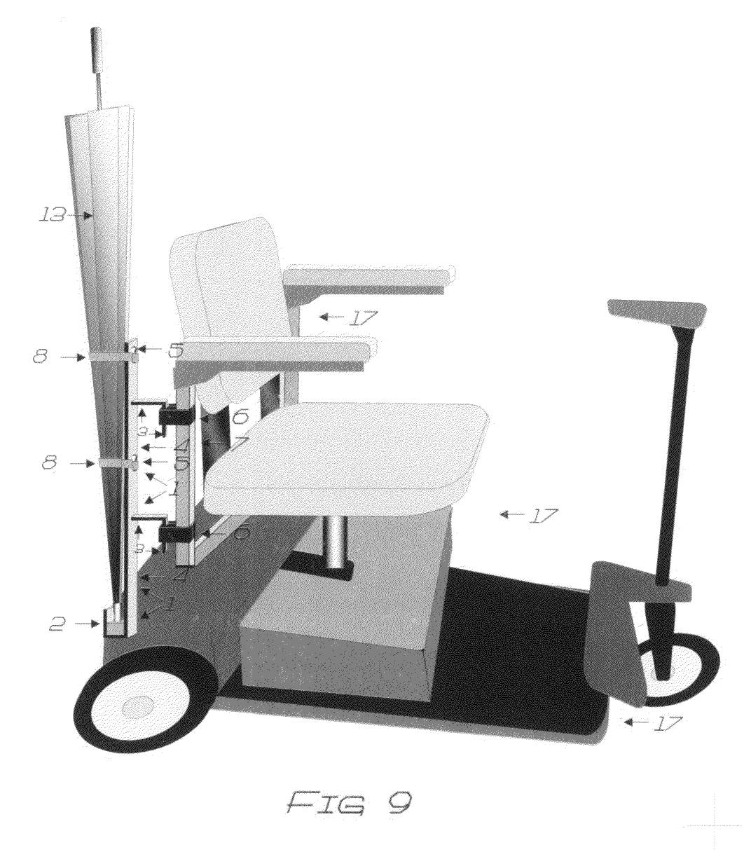

Turning to the embodiments illustrated throughout the drawings, the detachable holder, object of the present invention 1 includes primarily a support frame 4. This support frame is sized in different lengths and widths in order to facilitate use with different items that might require different lengths and/or widths. The support frame 4 includes at its lowest extreme a tip support 2. This tip support is where the tip, end or edge of the item is placed and this tip support 2 supports most of the objects weight. The support frame 4 also includes two hanger prongs 3, the means by which the present invention is attached and detached to the hanger brackets 6, which are required to be attached to the vehicle anchor tube 7, these anchor brackets 6, would be made in different configurations to fit on the mobility vehicle which the user intends it for. The support frame 4, also has two or more keyhole shaped cutout or openings 5, in it. These keyhole cutout/openings 5, are used to attach Velcro strips 8, round rings or short round tubes 9, clips 10, bungee ties 11, or any other method which presently exists or is developed to further support attach or hold the items which are being carried by this invention. In FIG. 9 we can see the object of the present invention 1, being utilized to carry/secure an umbrella 13, on one of the anchor tubes 7, in this case one of the arm supports of an electric powered mobility scooter 17.

1-5. (canceled)

6. A holder for securing an object to a tube, comprising:
an elongated support member including a first side, a second side opposite said first side, and an end, said support member including an attachment device extending from said first side and adapted to attach said support member to the tube, said support member including a tip support adjacent said end and extending from said second side; and
a hook and loop connector strip attached to said support member, said hook and loop connector strip adapted to secure an object to said support member.

7. The holder according to claim 6, wherein said attachment device includes a plurality of angled prongs extending from said support member.

8. The holder according to claim 7, in combination with an electric scooter, wherein the electric scooter is constructed with the tube, the tube has a plurality of brackets attached thereto, and said plurality of angled prongs are inserted into said plurality of brackets to attach said support member to the tube of the electric scooter.

9. The holder according to claim 7, in combination with an electric scooter and the object to be secured by said support member of the holder, wherein:
the electric scooter is constructed with the tube, the tube has a plurality of brackets attached thereto, and said plurality of angled prongs are inserted into said plurality of brackets to attach said support member to the tube of the electric scooter;
said tip support supports the object and said hook and loop connector strip extends around the object to secure the object to against said support member; and
the object is an umbrella.

10. The holder according to claim 7, further comprising a ring attached to said second side of said support member, said ring being adjacent said tip support, said tip support having internal dimensions, said ring having internal dimensions greater than the internal dimensions of said tip support, the internal dimensions of said ring adapted to receive an object that will not fit in said tip support.

11. A kit of components for securing objects to a tube, comprising:
an elongated support member including a first side, a second side opposite said first side, and an end, said support member including an attachment device extending from said first side and adapted to attach said support member to the tube, said support member including a tip support adjacent said end and extending from said second side, said support member including a first connector; and
a plurality of different types of securing devices adapted to secure different types of objects to said support member, each one of said plurality of securing devices including a second connector adapted to mate with said first connector of said support member.

12. The kit of components according to claim 11, wherein said second connector of each one of said plurality of securing devices is a protuberance and said first connector is an opening formed in said support member.

13. The kit of components according to claim 12, wherein said plurality of different types of securing devices includes a round tube and a clip.

14. The kit of components according to claim 13, further comprising an additional securing device adapted to secure an object to said support member, said additional securing device selected from the group consisting of a hook and loop connector strip and a bungee tie.

15. The kit of components according to claim 11, wherein said attachment device includes a plurality of angled prongs extending from said first side of said support member.

16. The kit of components according to claim 15, in combination with an electric scooter, wherein the electric scooter is constructed with the tube to which the objects will be secured, and wherein said attachment device attaches said support member to the tube of the electric scooter.
